(19) United States
(12) Patent Application Publication
(10) Pub. No.: US 2002/0056043 A1
(43) Pub. Date: May 9, 2002

(54) Method and apparatus for securely transmitting and authenticating biometric data over a network

(75) Inventor: Randal W. Glass, Cherry Hill, NJ (US)

Correspondence Address: Susan C. Murphy, Esquire, WOODCOCK WASHBURN LLP, 46th Floor, One Liberty Place, Philadelphia, PA, 19103, US

(73) Assignee: Sensar, Inc.

(21) Appl. No.: 10/020,791

(22) Filed: Oct. 30, 2001

Related U.S. Application Data
(63) Continuation-in-part of application No. 09/232,538, filed on Jan. 18, 1999.

(51) Int. Cl. H04L 9/00

(52) U.S. Cl. 713/179

(57) ABSTRACT

A method and apparatus for collecting and securely transmitting biometric data over a network contains a sensor, preferably a camera, for collecting biometric data and code generating hardware and software. The camera data is digitized and a unique code which is a function of the digitized camera data, a secret key and a transaction token is attached to the digital file. The code may identify the sensor which acquired the biometric information, a time at which the biometric information was acquired, or a time interval during which the data is considered to be valid, and a unique transaction code. The data and code are transmitted over a network to a server which authenticates that the data has not been altered by recomputing the code using its own knowledge of the secret key and transaction token needed to generate the code. If the data is authentic the server then computes a biometric template using the data. This biometric template is then compared to a previously defined biometric template to identify the user and give the user access to a secured resource. Components to generate the biometric template may be included in the imaging device. A mutual authentication system may verify that both the server and the client are authentic. The system can be used for online banking and Internet commerce transactions.

CROSS-REFERENCE TO RELATED CASES

This application is a continuation in part and claims priority to U.S. application Ser. No. 09/232,538, entitled “Method and Apparatus for Securely Transmitting and Authenticating Biometric Data Over a Network,” filed on Jan. 18, 1999, which is herein incorporated by reference.

### FIELD OF THE INVENTION

This invention relates to the field of transmission of biometric data and in particular the transmission of biometric data from a camera or other sensor to a server at a remote location over a network in a secure manner.

### BACKGROUND

Many situations occur in which it is necessary to identify a person seeking to enter a secured location, use a computer system or perform a financial or other transaction to assure that the person is authorized to perform the task. There are several methods known as biometrics for recognizing or identifying an individual. These methods include analyzing a signature, obtaining and analyzing an image of a fingerprint and imaging and analyzing the retinal vascular patterns of a human eye. Recently the art has used the iris of the eye which contains a highly detailed pattern that is unique for each individual and stable over many years as a non-contact, non-obtrusive biometric. This technique is described in U.S. Pat. No. 4,641,349 to Flom et al. and U.S. Pat. No. 5,291,560 to Daugman. Biometric identification systems take an image of the person being identified at the time he seeks to perform the task. This image is then processed to extract certain features. The result of this processing is an iris code in the case of U.S. Pat. No. 5,291,560 or in more general terms, a biometric template. This newly computed biometric template is then compared with a previously filed biometric template to make the identification and then authorize or refuse the person to perform the task.

Verification of an individual's identity or identification of an individual via automated biometric devices such as iris systems and some fingerprint systems rely on digital imaging technologies. The raw biometric data of the individual's presumably unique features is obtained by a system consisting of optics, camera, and electronics which capture and digitize the scene presented to the camera. The digital representation of the image (i.e. the raw or unprocessed image data) is then processed by an algorithm which converts the image data into a particular representation, called a biometric template. The biometric template is suitable for matching against a previously stored template to verify the individual's identity or against multiple templates to identify an individual. This method is illustrated in the flow chart shown in FIG. 1. Frequently, the conversion to the biometric template and subsequent matching is performed by a computer that is situated at a location remote from the camera or sensor which collects the biometric data. This remote conversion and matching is done so that the integrity of the biometric template computation algorithm is maintained by not distributing it to non-secure locations such as in a user's home computer. Thus, the digitized unprotected biometric data must then be transmitted from the camera to the remote computer. Such transmission may occur over a direct and dedicated transmission line, over a public carrier such as a telephone system or even over the Internet.

Any biometric system can be defrauded if an attacker could substitute the raw image data prior to the conversion to a biometric template and subsequent matching. That is to say, if Mallory wished to impersonate Bob, he would first capture Bob's raw image data and store it; then he could attack the target system by artificially “injecting” the fraudulent image data at the correct time and place so that the template conversion and match would unwittingly conclude that it was Bob appearing in front of the camera. The potential for such an attack increases when the image acquisition process may be separated from the template conversion and match process, such as in a case where a remote terminal equipped with the imaging system (a client) sends images across an internal network, or the Internet, to a central server which performs the conversion and match. Image tampering can occur at any point from the camera to a “secured” server system. The server system itself may also be attacked, but the probability of a successful attack against this system is extremely small without “inside”information and access.

There are several key places where an attacker could perform this image substitution. An attacker could replace the camera with a system that mimics the camera functionality thereby providing a previously stored image to the rest of the system. An attacker could gain access to the inside of the client system's host and replace the contents of the memory or frame store containing the “real” image data with the memory representation of a previously stored image. Finally, the attacker could gain access somewhere along the communications path between the client system and the server system and replace the image while in transit. Thus, there is a need for a method and device which can transmit biometric data while preventing image substitution or tampering.

We recognize that attacks could be made using an artificial or contrived scene. For example, an attacker could present a counterfeit eye to an otherwise unmolested system. These are completely different types of attacks. The technology to counter such threats exists and attacks of this type are not relevant to the present discussion. Rather the present invention is aimed at maintaining the integrity of an image containing biometric data and preventing image tampering or substitution.

There have been developed a number of techniques for detecting image or data tampering and unauthorized copying. Much of this effort has been directed to preventing and detecting copyright infringement and counterfeiting. The most widely used techniques apply a watermark on the image or embed code signals. U.S. Pat. Nos. 5,768,426; 5,809,139 and 5,822,432 disclose methods for marking digital video signals by adding bits of information to the signal or image file in a predetermined way so that the data appears as noise to the ordinary observer but can be detected as a watermark or code by the owner of the signal or image file. U.S. Pat. No. 5,613,004 discloses a steganographic method and device that encodes a digitized data stream with special keys. The patent also teaches that codes or other information can be prepended or appended to the data stream. Another known technique for watermarking images is to change the brightness of selected pixels in a predetermined pattern. This method is disclosed in U.S. Pat. No. 5,825,892. However, none of these references are concerned with assuring that biometric data has not been compromised to prevent unauthorized access to a secure system or location.

It is imperative that raw biometric image data be secured in such a manner that undetectable substitution or tampering of the image data prior to the biometric template conversion is extremely difficult to perform. In addition, it may be desirable to encode image data such that images have a finite lifetime. Then an encoded image cannot be used to identify a user more than once (or n times), and/or images remain valid only for some predetermined time period after which they will not be processed by the biometric algorithm since they have been deemed invalid by the authentication system or server. Furthermore, it may be desirable that the biometric authentication server be provided with a unique ID of the imaging system providing the image data to it. With these features, an authentication server has the ability to determine that it is indeed Bob in front of camera ID#xyz for transaction ID#pdq, that capture occurred within time interval t2-t1, and that the image could not have been altered nor been re-used from some other transaction.

For example, in an electronic commerce application, for each transaction there would be exactly one image associated with that transaction. Also, should the client fail to provide the server with the image within some time window, the transaction would not be authorized. This provides additional levels of protection by preventing later substitution of previously valid images and forcing an attacker to develop methods that work within the time-out period, which adds considerable difficulty to the attacker's task.

In order to provide adequate security, there must be a “secret” shared only by the sender (the camera) and the recipient (the system performing the authentication of the image.) This secret must remain secure, or else the security of the entire system may be compromised. The “secret” shared between the camera and the authentication server is in the form of a digital “key” or, in some cases, a pair of keys. The camera's tamper-resistant/responsive packaging protects the secret key embedded inside. The server's key is protected by security measures such as electronic firewalls, physical access control, and other known methods of providing high levels of security to sensitive data.

In recent years there has been an increase in the use of personal computers both in the office and at home. Initially these computers were used almost exclusively for word processing and database applications. Today personal computers are being used for a variety of communications activities ranging from electronic mail and file transfer to electronic banking and online commerce. Thus, there is a need for a system that can be connected to a desktop computer which can ensure the secure transmission and reception of biometric data over an unsecured network thereby enabling a user to have his identity verified at a remote location so that such user can be authorized to make the financial transfer or transaction that he has requested.

### SUMMARY OF THE INVENTION

We provide a system and methodology which can provide secure transmission and subsequent authentication of biometric data for use in a client-server scheme in which the biometric data is transferred from one computer over an unsecured network to another computer for identification or verification of a user. We prefer to provide a camera which functions as a sensor to collect the biometric data. That data is digitized into a biometric data file. A code is applied to that file. Then the file with code is output to a network for transfer to an authentication server system. The authentication server system validates the data by recomputing the code from its knowledge of the input data needed to generate that code. If the data is authenticated, the server distills the biometric data file into a biometric template for use in verifying the identity of the user.

We further prefer to provide a token generator in the authentication server which sends a token to the camera or other sensor. That token is applied to the digital file before it is transferred to the authentication server. The token defines a unique transaction and couples the biometric data to the transaction thus preventing use of the biometric data at a later time or putting a time limit as to when the data becomes invalid.

The code which is applied to the image for transfer is computed as a function of the image, the token and a secret key associated with the camera. The secret key assures that an attacker with knowledge of the image, token and code generation algorithm cannot create a valid code for a substituted or tampered image. The secret key may be a serial number or other identification number that is unique to the camera or sensor that collects the biometric data. If such a code is used we can provide a separate camera certification authority which contains a listing of authorized cameras. The authentication server would consult the camera certification authority each time a new image is received so that it has knowledge of the secret key corresponding to the sending camera. The camera certification authority may be a single database residing within the authentication server or it may reside in a separate computer. A separate certification authority is useful when there are two or more authentication servers connected to the network.

In one embodiment, the device that obtains the biometric data may also contain the means to create the biometric template from the biometric data. If the data (the template) is communicated externally, such as to a server which performs the template matching operation, the problem of authenticating the data and making certain that the data has not been altered and has come from a known device is still present. A mutual authentication procedure verifies that both the server and the client are authentic entities.

Other objects and advantages of the invention will become apparent from a description of certain present preferred embodiments shown in the drawings.

### BRIEF DESCRIPTION OF THE DRAWINGS

FIG. 1 is a flow chart showing the basic steps in performing biometric identification as has been done in the prior art.

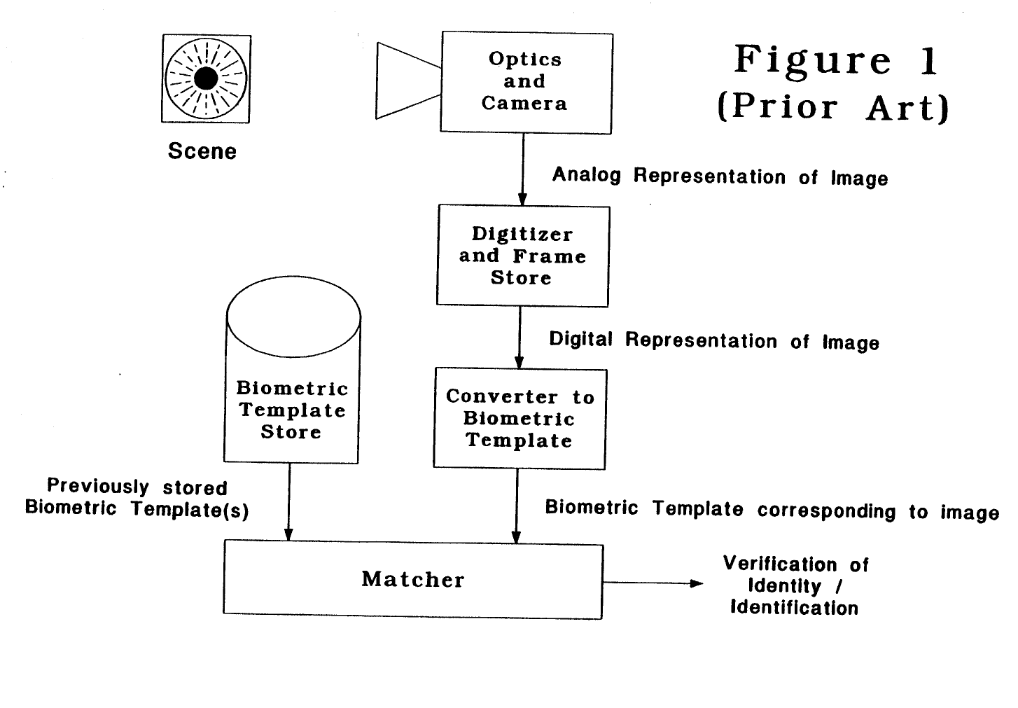

FIG. 2 is a block diagram of a biometric identification system which transfer biometric data over a network and contains our security system.

FIG. 3 is a functional block diagram of a present preferred imaging system which is used in the identification system shown in FIG. 2.

FIGS. 4 and 5 are diagrams illustrating the watermarking process.

FIG. 6 is a diagram of an embodiment of the client server network in accordance with the present invention.

FIG. 7 is a diagram illustrating one operational transaction conducted using our method.

FIG. 8 is a diagram illustrating a second example operational transaction conducted using our method.

FIG. 9 is a functional block diagram of an exemplary biometric identification system wherein the device that obtains the biometric data includes components to convert the data to a biometric template.

FIG. 10 is a functional block diagram of an exemplary biometric identification system wherein the device that obtains the biometiric data includes components to perform biometric matching.

FIG. 11 illustrates a block diagram of an exemplary cryptographic module in accordance with the present invention.

FIG. 12 is a flow diagram illustrating an exemplary process for signing a key for a client or a server.

FIG. 13 is a flow diagram illustrating an exemplary mutual authentication procedure in accordance with the present invention.

### DETAILED DESCRIPTION OF THE INVENTION

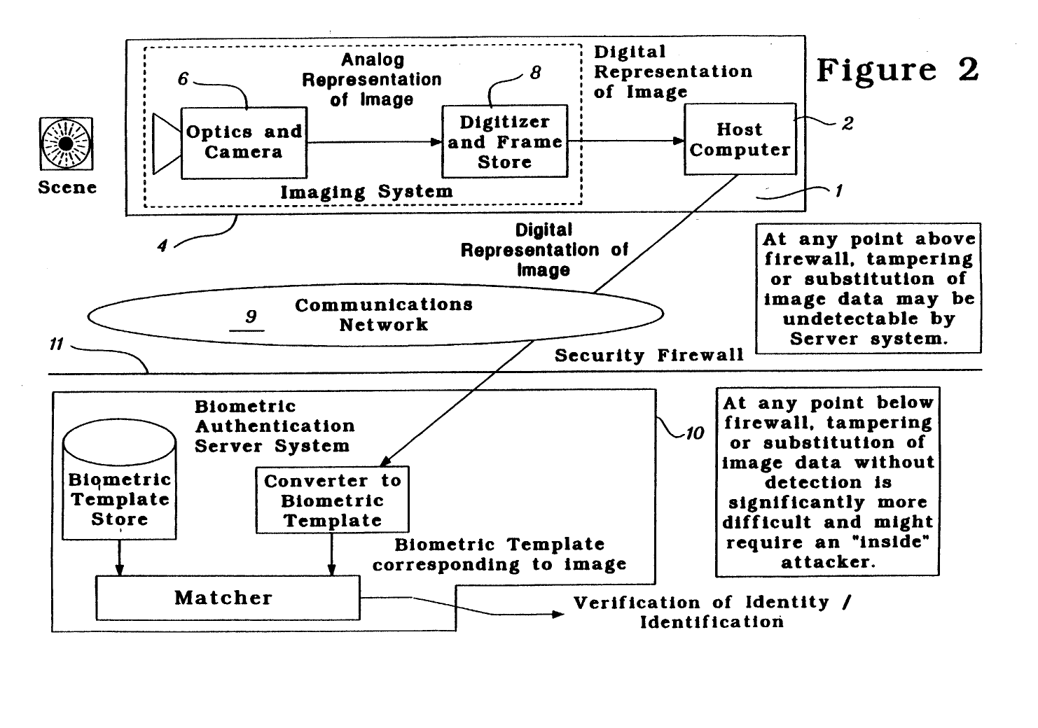

A present preferred embodiment of our system is employed in a client server system like that illustrated in a FIG. 2. The client system 1 consists of a personal computer 2 which is labeled as a Host Computer in the diagram. The host computer 2 can be any commercially available personal computer or business computer, or embedded processor which has sufficient memory to hold the biometric image file and a modem or network communications hardware and software to allow the biometric image file to be transferred to the authentication server. There is a separate imaging system 4 which is connected to the host computer. The imaging system contains a camera 6 with associated optics or other sensor for collecting the biometric data from the user. Typically, the biometric data will be an analog representation of an image which is then digitized and stored for later transfer. We prefer to provide a digitizer and memory or frame store which digitizes the image and then stores it in the imaging system 4 for later processing and transfer. To secure the raw image data, additional electronic hardware and software are included in either the digital camera package or the imaging system. These additional components embed information into the image data before it leaves the camera or imaging system in such a manner that the image data can be subsequently authenticated and validated as uncorrupted by some other external data processing element downstream of the camera, such as the biometric authentication server 10. A digital representation of the image which has been appropriately coded for security is output from the imaging system to the host computer 2 for transfer across a network 9 to the authentication server 10. Before entering the authentication server the data should pass through a firewall 11. The firewall would be used if the network is the Internet or another public carrier. A firewall may not be needed if the client system is connected to the authentication server over a private transmission line.

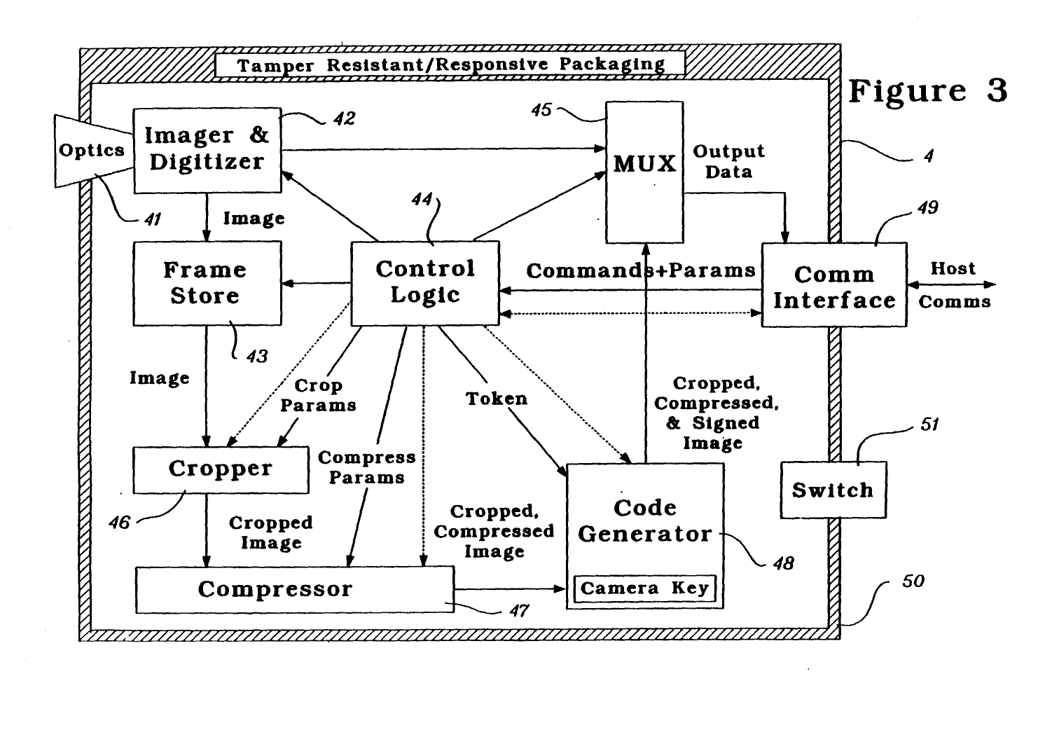

The entire package which contains the imaging system 4, must be tamper-resistant so that it is extremely difficult to access the internal elements of the package without detection or actual destruction of the device. It is essential to ensure that the integrity of the acquired images and codes to be transmitted over the network have not been compromised. This is especially important in applications where large value transactions might occur. Thus, in our preferred embodiment, the imaging system 4, will be enclosed in a tamper resistant package 50 which will be used to detect unwelcome intrusion and render the system useless. The tamper resistant package can be passive in that any opening to the device will cause its ultimate destruction. Alternatively, the packaging could utilize at least one chassis intrusion detector or switch 51 shown in FIG. 3. Switch 51 will signal the control logic 44 (which could be implemented by a microcontroller) to return to a non-functioning state similar to that found during assembly. This non-functioning state will essentially delete key software routines related to generating biometric data. It may also delete special battery backed up ram tables which include security or encryption information. Thus, if an intruder does gain access to the system he cannot inject video nor obtain codes, or even operate the system software or firmware thereby making his attack useless. Therefore, a substitution or tampering of image data after output from the secured camera will be detectable via downstream data processing, and substitution or tampering of image data prior to application of security information would be extraordinarily difficult or impossible.

The security function will be in effect only after system software is loaded and enabled. The security function will remain in effect until intrusion is detected or the system software is reloaded using a special protocol.

A present preferred configuration of our imaging system 4 is shown in FIG. 3 wherein data paths are shown in solid lines and control signal paths are indicated by dotted lines. Optics 41 direct light from a scene to an imager which may be a CCD camera, a CMOS device or other two dimensional imager which creates a digital image. Consequently, we identify this component 42 as Imager & Digitizer. The digital image is sent to a multiplexer 45 and/or a frame store memory 43. Control logic unit 44 determines where the image is sent. The image in the frame store 43 is sent through a cropper 46 and compressor 47 to create a cropped and compressed image that is sent to a code generator 48 which generates a code that is applied to the image. Cropping and compressing may be optional for certain applications but have the advantage that they can reduce the amount of data that needs to be transmitted across the network, thereby speeding transmission. A cryptographic technique is employed inside the code generator to create a digital signature for each frame of image data acquired by the camera and optics. This cryptographic process is implemented by the processing elements mentioned previously. The digital signature preferably is a secure hash function which takes the following as inputs: each byte of image data in the frame; a “secret key” which is stored and remains hidden inside the camera; and optionally a digital “token” entered into the camera electronics by the host. Alternatively, the token could have come from the authentication server. The “hidden” or “secret” key is required since an attacker, with an image plus a token plus knowledge of the digital signature algorithm could, without this secret key, mimic the authentication functionality of the camera.

The camera “key” can be a small block of data contained inside the camera that is used in the digital signature algorithm. Optionally, the key could be a unique identifier for the camera. Depending on the type of scheme used, the camera “key” may simply be an arbitrary value assigned to every camera, an identifier for a batch of cameras, a unique camera identifier, a unique key for a symmetric signing algorithm, or a one half of a key-pair for an asymmetric signing algorithm. The authentication server 10 must have a priori knowledge of the secret key (or in the case of an asymmetric algorithm it must have knowledge of the complementary public key.) Thus, for a given camera, this key does not change between transactions however, different cameras may have different keys. It is also possible to have a scheme where the camera keys can change such as on a monthly or other basis. In this case, the authentication server or some other authority could send an new encrypted key to the client which is encrypted using the key currently in the camera. The client sends this encrypted key to the imaging system 4 which receives the new data over the ommunications Interface 49. This data is then sent to the Code Generator 48 which decrypts the new key using its current key and stores the new key for later use. The “token” is a block of data generated for each and every transaction; each token is unique and is never re-used. Tokens can thus be used to identify any particular transaction. Any function which can be guaranteed to produce a unique output may be used to generate tokens. The use of a token provides an added level of security by coupling image data to a specific transaction.

The digital signature previously mention can be implemented as a hash function. The output of the hash function is a smaller block of data than its input elements. An important characteristic of a hash function is that given the same inputs, reapplication of the hash function will compute the same output. Additionally good security hash functions have the characteristic that any change in the input elements will result in a major change of the output data block. In particular, if the hash function is computed over the image data, any change in the image data will result in a different hash function output. The digital signature of the data can be sent to another system (i.e. the authentication server) along with the original data; and the receiving system can, with the same or complementary token, compute a signature of the original data and check it against the signature sent with the data. If the signatures match, the data can be assumed to not have been altered with an extremely high confidence level. Thus, if a function DS(x, y, z), where x is the image data, y is a token, and z is the secret key, produces an output Q, then given x, and Q via some data exchange means and with knowledge of both original values y, z, as well as the hashing function DS(),a recipient can compute Q′=DS(x, y, z). If Q=Q′ then x, y, and z have not been altered, otherwise one or more of the data items have changed. In practice, the hash function would be computed over the combination of the image data, the optional token and the secret key. For added security the DS function can operate as an asymmetric algorithm, in which case one or more of the functional parameters may be different (but complementary) on the sender's and recipient's sides.

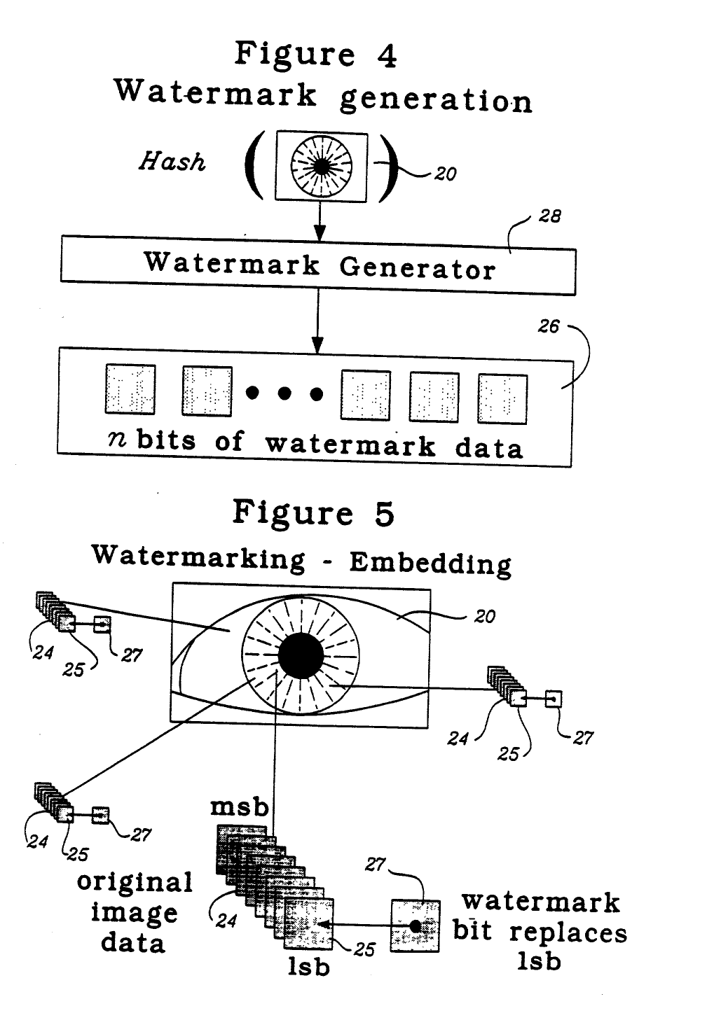

There are a number of ways the digital signature computed by the camera can be sent back to the authenticating system. The most straightforward method is to append (or prepend) the signature to the data and send the complete package back to the authenticating system. Another technique would be to use a digital watermarking technique to embed the signature information directly into the original image data. This can be performed in a manner such that the embedded signature disappears in the image, and cannot be distinguished from random noise. The receiving system can determine the decoding sequence of the embedded signature to separate it from the image and then can perform the authentication as mentioned previously. FIGS. 4 and 5 illustrate the watermarking technique. Each image 20 is comprised of a series of raster lines. Each raster line is further divided into a elements called pixels. Each pixel is represented by some number of bits. Thus, the lines each contain a series of pixels m bits deep. A watermark is applied by changing some of those bits typically one or more of the least significant bits. As indicated in FIG. 4 the digitized image is passed through a watermark generator 28. This device could be considered to be the code generator 48 shown in FIG. 3. The watermark generator creates n bits of watermark data 26 which are applied to the image according to a predetermined plan. This plan is illustrated in FIG. 5 wherein one bit 27 from the watermark replaces one bit 25 from selected sets of original image bits 24. Note that if a watermarking technique is used to authenticate the image, any image processing which alters the data after watermarking (such as lossy compression) will not allow for certainty in the authentication process, which may be undesirable for high security applications. If a token scheme is used, the token is generated by the server 10 and communicated to the client system 1 just prior to image capture. The token is communicated to the camera 6 where it is included in the image authentication algorithm in such a manner that the token or a complementary token held only by the server, in addition to the secret key, is required to properly authenticate the image. Thus, in order for an image to be recognized by the server as valid, the image cannot have been altered in any manner after being output from the camera, and the image must include within the digital signature, the token valid for the transaction.

Because the token is generated by the server and known by the server, and since each transaction has a unique token associated with it and embedded in the image signature, images are guaranteed to be valid only for one transaction and cannot be reused. Also, since the server generates a token and in effect initiates image capture, the server can set a clock which causes tokens to expire after some period of time. In fact, a clock expiration scheme does not need tokens to work; as long as the transaction can be timed and there is a finite window of opportunity for the client to send an image back to the server, some protection is offered. The token merely makes data substitution more difficult, since it is easier to track images and transactions. Since the server is the only computer system generating the tokens, initiating the command to capture, and maintaining the time-out clock, there is no need for clock synchronization between the client and server systems. However, a time stamp may be included in the algorithm for generating the token, or the token itself may be some representation of time. Regardless of the algorithm, the uniqueness of each token must be maintained or security could be compromised in some circumstances.

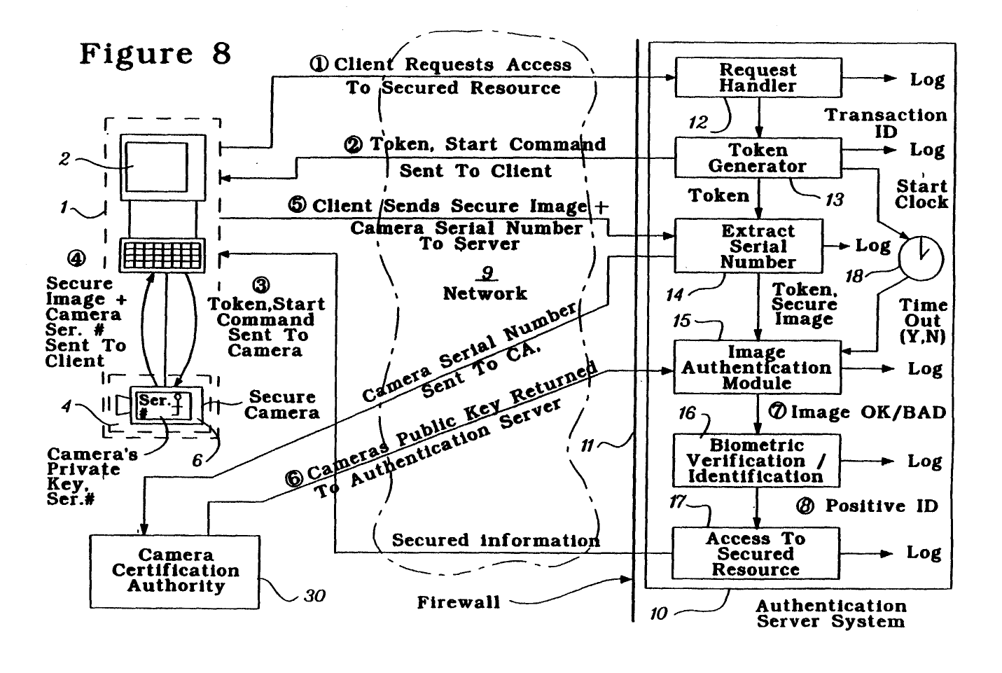

Another possible variation of the implementation of the token scheme involves generating unique values which function as keys for a digital signature lgorithm which uses a key or keys. This is slightly different than an implementation in which the token generator merely generates unique blocks of data, since the token generator must generate unique, but valid, keys. This also offers the ability to use an asymmetric digital signature algorithm. In the case of symmetric algorithms, only one token, or key, is used for both the client signature and the server verification. For an asymmetric algorithm, two tokens or keys are generated. The first key is sent to the camera, and the second or complementary key is kept within the server. The latter method provides additional security since one key never leaves the secure server. An image acquisition device which includes secured image authentication may be enhanced by including individualized keys into the hardware/firmware/software of the system. One possible scheme would be to embed asymmetric key pairs in the camera along with a unique camera serial number. Each key pair would be unique, and would be generated and embedded into the camera at the time of manufacture inside a secure facility. This type of system is shown by the diagram in FIG. 8.

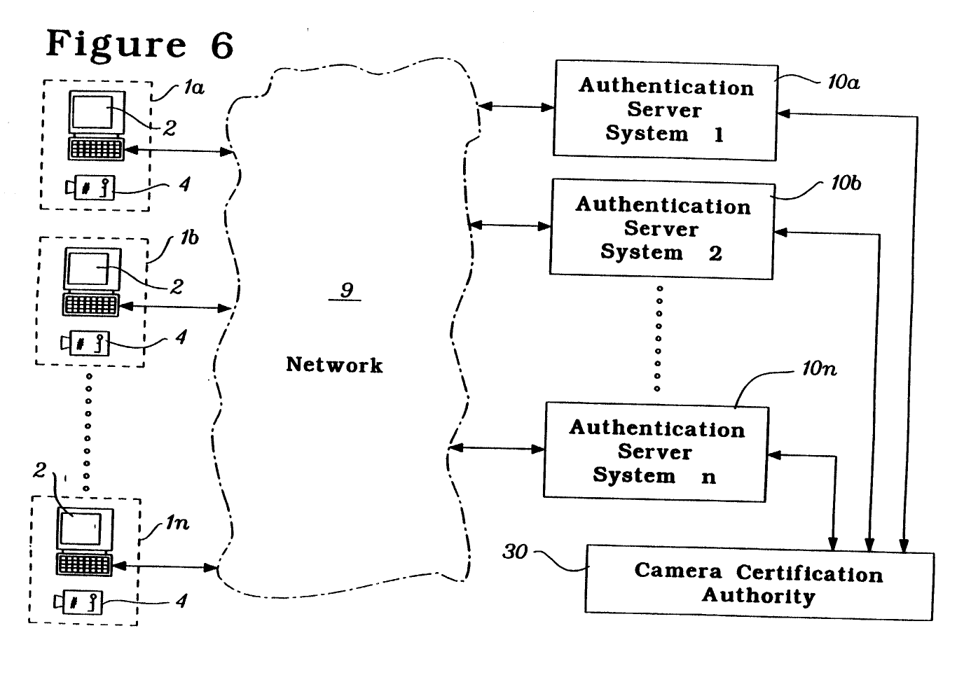

FIG. 6 shows how client and server systems would be connected together. In FIG. 6 there are several client systems 1a, 1b through 1n. Each client system has a host computer 2 and associated imagining system 4 which includes a camera. The client systems can be connected to one of many authentication servers systems 10a, 10b through 10n. Theses servers may be associated with other computer systems that perform online banking transactions. Other authentication servers may be associated with other vendors whose services or products may be purchased over the network 9. This network most likely will be the Internet but it could be another public carrier such as a telephone system or satellite transmission system. When the selected server receives a request for access from on of the clients it sends a query for one of the keys, the public key, to a central Camera Certification Authority 30, which would hold all public keys for all cameras. The inquiry contains the serial number reported by the camera. The public key would be used to determine whether a particular camera signed the image received by the server using that same camera's internal private key. Since the image would have been signed inside the camera using the private key, the authentication server is able to use the public key to determine irrefutably that the given camera produced the image in question. In addition, by using a central Camera Certification Authority, individual cameras may be temporarily or permanently disabled by deactivating or changing a particular camera's stored public key. In this manner, if a camera is believed to have been compromised, it can be marked as a rogue by the certification authority and the certificate revoked. Thereafter, the authentication server would not have the ability to validate any “signed” images from that particular camera, effectively disabling it.

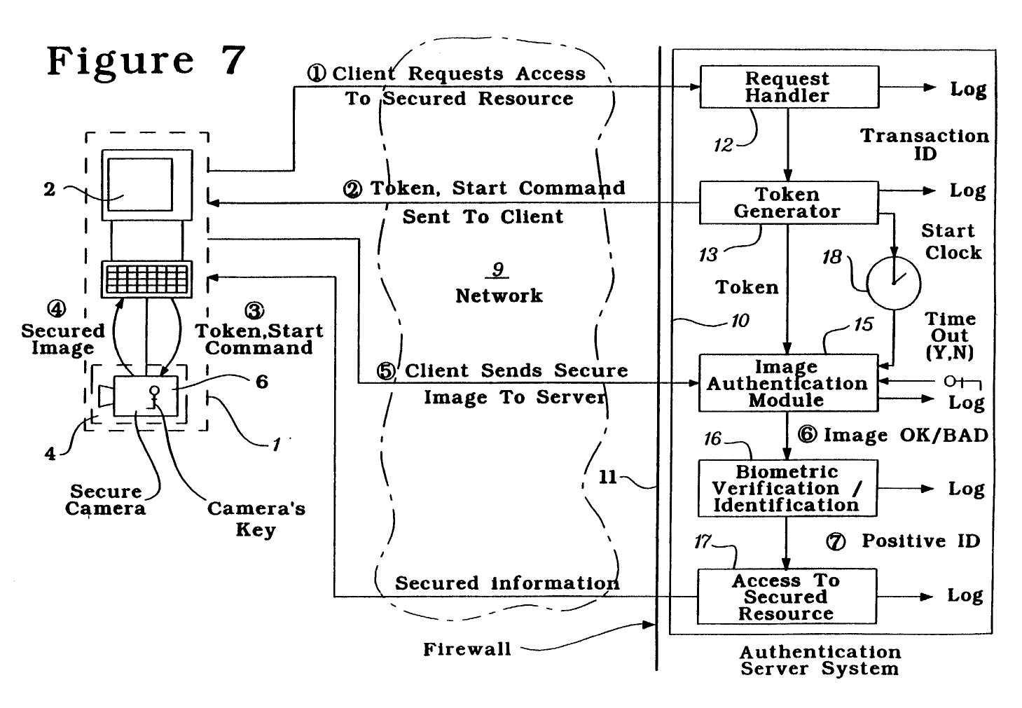

Two operational scenarios between a client and server are illustrated by FIGS. 7 and 8.

The first operational scenario shown in FIG. 7 is a transaction in which the authentication server is functioning as a “gatekeeper.” The authentication server allows access to data or services only to authorized individuals. For example, an on-line banking application which would require biometric identification in order to provide positive identification and protect high-valued monetary transfer functionality would have such an interchange. This approach illustrates using a method that implements the unique-per-transaction based token exchange protocol. In this example, the secret key embedded in each camera is the same key for all cameras and this secret key is known by the authentication server.

The second operational scenario shown in FIG. 8 is a transaction similar to the first; however, every camera has a unique secret key and unique serial number. For each key embedded in a camera, there is a complementary “public” key stored in a central, secure database which acts as the camera “Certification Authority” that allows the system to identify the source of every image.

Referring to FIG. 7 the transaction begins when the client system 1 requests access to a resource protected by the server computer 10. For example, an individual wishes to use his computer 2 to access the money transfer screens that enable him to move funds from his bank account to another account. This could be a transfer from his savings account to his checking account or a payment of bills by sending funds to the account of one of his vendors. The authentication server 10 has a request handler 12 which receives the inquiry. Upon receiving the request the authentication server computer 10 initiates a security transaction to ultimately provide access to the protected resource. The server, as part of the transaction, generates a unique token or set of unique tokens, one of which is sent back to the client. The tokens are created by a token generator 13 and may be generated as a result of a random number generator, a random key generator, a unique transaction number, a time stamp, or a combination of any or all of the above.

The client computer receives the token, and sends it to the imaging system 4 connected to the client's computer 2. The imaging system contains a camera 6 which has a secret key indicated by the key icon. The camera is then instructed to generate a secure image. The camera accepts the token, captures an image, and uses a digital signature algorithm which takes the image, token, and the camera's secret key as parameters to provide a digital signature of the particular image. The camera outputs the secured image to the client computer 2. The client computer, which may or may not do some processing of the image, ultimately sends the image to the server 10 over the network 9. Transmitted along with the image is the digital signature either embedded directly into the image or alongside the image in the data package sent to the server. The server checks that the image has not been tampered with by computing the same or complementary digital signature algorithm on the data, using its knowledge of the token or complementary token respectively, along with the server's copy of the secret key. This is performed in the image authentication module 15 where the computed digital signature is compared to the digital signature from the client. The authentication module contains or receives from another component in the Authentication Server System information that enables it to recognize the key from the secure camera as indicated by the key symbol input to box 15. If the outputs are the same the received image is valid and belongs with the particular transaction. The server can then take the image and perform the biometric identification as indicated by box 16. Upon passing the biometric identification the client is provided access to the secured resource which is shown as box 17. A record of the transaction can be logged by the server system, which could contain, among other things, the original, secured image data originally sent by the client. This data can provide irrefutable evidence of the transaction if required.

We prefer to log each step of the transaction as indicated by the word Log. We also prefer to provide a clock 18 which is used in checking time-stamped data as well as recording the time of each transaction.

The second example transaction is diagrammed in FIG. 8. As in the first example a client system 1 is connected to an authentication server system 10 through a network 9. During camera manufacture, a public key, private key and serial number are assigned to each camera inside a secure facility. The public key and serial number are entered into a central database accessible by a server computer which acts as a camera certification authority 30. The private key and serial number are programmed into the camera. This private key is the secret key for the camera. An imaging system containing the camera is connected to a client computer 2 and transactions may proceed.

The transaction begins when the client system 2 requests access to a resource protected by the server computer 10. For example, an individual wishes to access the money transfer screens at his or her computer. The authentication server computer 10, upon receipt of a request by the request handler, initiates a security transaction to ultimately provide access to the protected resource. The server, as part of the transaction, generates a token or tokens using token generator 13, one of which is sent back to the client system 1. As in the previous example the generator tokens may be generated as a result of a random number generator, a random key generator, a unique transaction number, a time stamp, or a combination of any or all of the above. The client computer receives the token, and sends it to the camera, which is then instructed to generate asecure image. The camera accepts the token, captures an image, and uses a digital signature algorithm which takes the image, the token, and the camera's unique private key as parameters to provide a digital signature of the particular image. The camera outputs the secured image to the client, along with the camera's serial number. The client, which may or may not do some processing of the image, ultimately sends the image to the server 10. Transmitted along with the image is the digital signature and the camera's unique serial number, either embedded directly into the image or alongside the image in the data package sent to the server. The authentication server extracts the camera's serial number from the data package sent by the client as indicated by box 14. It sends this serial number to the central camera certification authority 30 which looks up that camera's public key. The public key is returned to the authentication server. Using module 15 the server checks that the image has not been tampered with by computing the same or complementary digital signature algorithm on the data, using the token or complementary token respectively, along with the camera's public key provided by the Camera Certification Authority 30. The output of the algorithm is checked against the digital signature from the client and if the outputs are the same the received image is valid and belongs with the particular transaction, and is known to have been generated by a particular camera identified by the serial number. The server can then take the image and perform the biometric identification indicated by box 16. Upon passing the biometric identification the client is provided access to the secured resource 17. A record of the transaction can be logged by the server system, which could contain, among other things, the original, secured image data sent by the client and the unique camera identification or key. This data can provide irrefutable evidence of the transaction if required.

In some applications, appending code to data may be deemed not secure enough since the data could potentially be viewed by some unauthorized person or organization. In this case, it is possible to include an encryption scheme so that after the code is generated both the data and code are encrypted data package prior to transmission from the client to the server. The server would then decrypt the encrypted data package prior to authenticating the data with the code. Those versed in the field will recognize that there are a number of valid encryption and decryption techniques with various levels of security that may be used to accomplish this task.

In accordance with aspects of the present invention, the device that obtains the biometric image data may also include components to generate a biometric template from the biometric image data. For example, a “smart” camera or other imaging device may comprise not only optical components, and an image digitizer, it may also comprise components to perform the conversion of the biometric image data to a biometric template. In the case of an iris-based biometric template, the device preferably comprises image-to-iris template conversion logic, and outputs template data instead of, or in addition to, image data. If the template is to be communicated externally, such as to a server which performs the template matching operation, it is desirable to authenticate the data and to ensure that the data has not been altered and has come from a known device or other source.

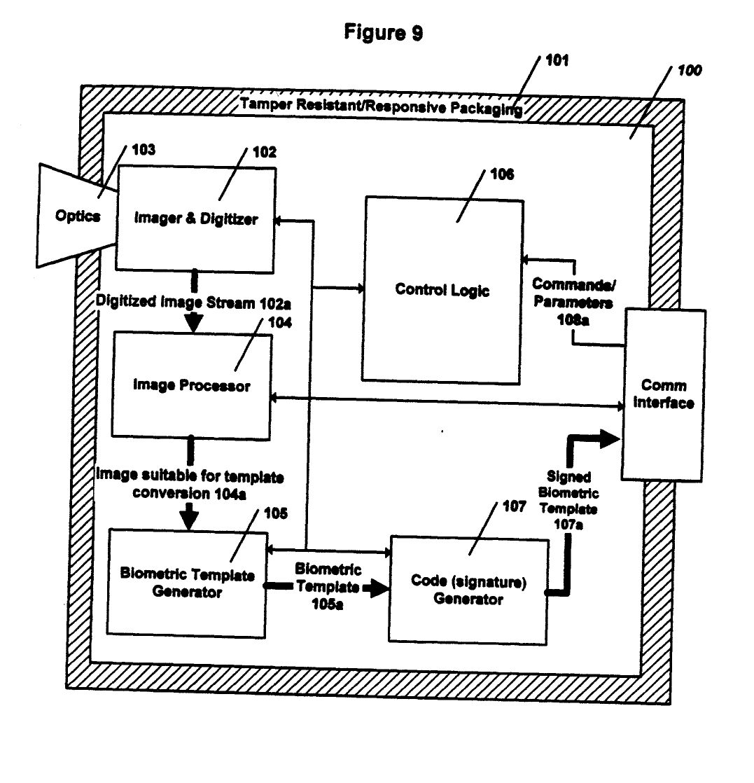

Preferably, the processing for template generation is performed before generating security code(s). That is, after generating the image data, the biometric template is generated and the biometric template is digitally signed. FIG. 9 is a block diagram of an exemplary embodiment of such a device.

As shown in FIG. 9, an imaging device (e.g., camera) 100 is encased or otherwise housed within a tamper-resistant package 101. The imaging device 100 may include optics 103, imager and digitizer 102, image processor 104, biometric template generator 105, control logic 106, code generator 107, and communications interface 108.

Imaging device 100 and an external host (not shown) may communicate through the communications interface 108. An external host may, for example, be a biometric authentication server or an intermediate host. The communications interface 108 may be capable of communicating directly to a biometric authentication server, or may communicate with the biometric authentication server through an intermediate host. The interface 108 may support simple communications protocols or advanced communications protocols such as, but not limited to, TCP/IP.

Imaging device 100 may be commanded to obtain a biometric data sample by the issuance of an external command, such as but not limited to, pressing a button or otherwise activating a switch on device 100. Alternately, or in addition, imaging device 100 may be capable of initiating communications (e.g. an image may be generated as a result of the presence of an object or being in front of imaging device 100).

In any case, appropriate parameters and commands 108a, such as a unique token, are preferably passed to imaging device 100 through interface 108. Optics 103 captures an image and imager/digitizer 102 converts the image into digital information (digitized image stream 102a).

Image processor 104 performs image analysis of the image 102a in order to determine if the gathered image is suitable for conversion to a biometric template. Image processor 104 may, for example, determine if the object is truly an image of an iris, and that it is in focus and is properly lit. Other determinations may also be made by image processor 104.

It is contemplated that an external host may also perform image analysis using additional control/communications logic and internal stores within the device.

When image processor 104 determines that the image data is suitable for template generation, the image suitable for template conversion 104a is passed to template generator module 105. Template generator module 105 produces a biometric template 105a. For example, template generator module 105 may convert an iris image to an iris template, such as that described in U.S. Pat. No. 5,291,560 to Daugman.

Biometric template 105a may then be signed using a code generator module 107. Code generator module 107 preferably implements the signing technique or other process or algorithm using a key or keys and token, producing a signed biometric template 107a. Signed biometric template 107a, secured against tampering, is sent to the external host through communications interface 108. Control logic 106 controls the overall behavior and logic of the camera and internal modules.

It should be noted that exemplary device 100 preferably outputs secured templates, and many other embodiments are possible, such as a device capable of outputting either an image or a template based on a command parameter. Such embodiments are included within the scope of the present invention.

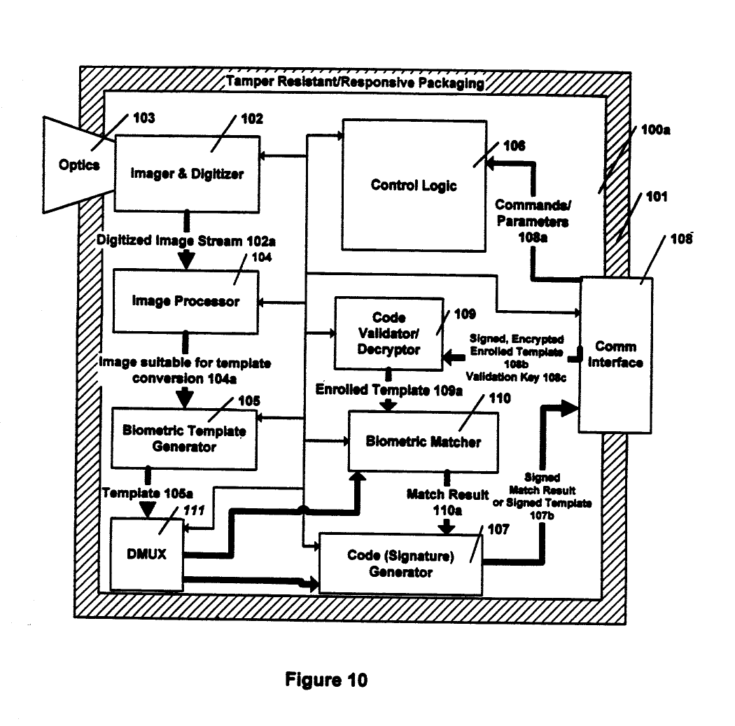

FIG. 10 illustrates an imaging device 100a as described in FIG. 9; however, the imaging device 100 described in FIG. 10 includes a code validator/decryptor 109, a biometric matcher 110 and a demultiplexor (DMUX) 111. Imaging device 100a has the capability to support local template matching in addition to template generation. In the present invention illustrated by FIG. 10, the external host or server does not have to provide the facility for the biometric match but does provide storage for previously enrolled templates. The previously enrolled templates may be used to match new candidate templates generated by imaging device 100a. The results of the match (“Template A matches template B” or “Template A does not match template B”) is desirably secured, so that an attacker cannot change the result of match to no-match, or vice-versa.

In FIG. 10, biometric matcher 110 includes the logic desirable for matching two biometric samples to produce a match result 110a. Match result 110a can be either “match”, that is, the two biometric templates compared come from the same object or being, or “no match”, that is, the two biometric templates do not come from the same object or being.

Imaging device 100a also comprises a security module 109 to decrypt and validate the integrity of the incoming previously enrolled template, received from a external servervia communications interface 108. The incoming previously enrolled template is received as a signed and encrypted template 108b and is accompanied by or includes a validation key 108c. Security module 109 authenticates the source of the template. An embodiment of imaging device 100a uses a secure private key embedded in imaging device 100a to perform the decryption, and the public key certificate of the sender (sent along with the data) for validation, certified by a third party certificate authority to provide authentication of the sender. Security module 109 outputs a decrypted and authenticated enrolled template 109a. Templates 109a and 105a are compared by biometric matcher 110. Match result 110a may be signed, creating signed match result 107b. Signed match result 107b may be sent via communications interface 108 to a host/server.

Because protective packaging envelops the logic, it is preferable that signed match result 107b is highly secured. Logic to direct the flow of the template, e.g. for template generation for output from imaging device 100a (such as for enrollment) versus matching, is preferably included in DMUX 111.

The methods and systems described above provide a number of attributes related to securing biometric data for transmission to a remote entity. For example, by signing the biometric data with the imaging device 100 or 100a, the integrity of the data is maintained. Further, a token is used to prevent the data from being re-used and to provide a reference to a particular transaction, and allows the data to be used only within a particular time window. Finally, techniques such as using digital certificates, certification authorities, and camera identifiers are used to allow the external server to determine where the data comes from, and whether that source is known and trusted that is, the server can authenticate the source of the data.

It is contemplated that additional cryptographic techniques may be used to provide additional levels of security. For example, it may be desirable for imaging device 100 or 100a to have the ability to identify the host/server, and to determine that the external server to which imaging device 100 or 100a will send the biometric data is known to be trusted. An attacker may then be prevented from posing as a biometric authentication service and gathering biometric data for unknown purposes, for example. Furthermore, it may be desirable for transactional privacy to be maintained. An attacker may be able to learn information about an individual by observing where biometric data travels, for example. If encryption techniques are used, the data being transferred is more opaque to a malicious observer, and so may elevate the overall security of the system.

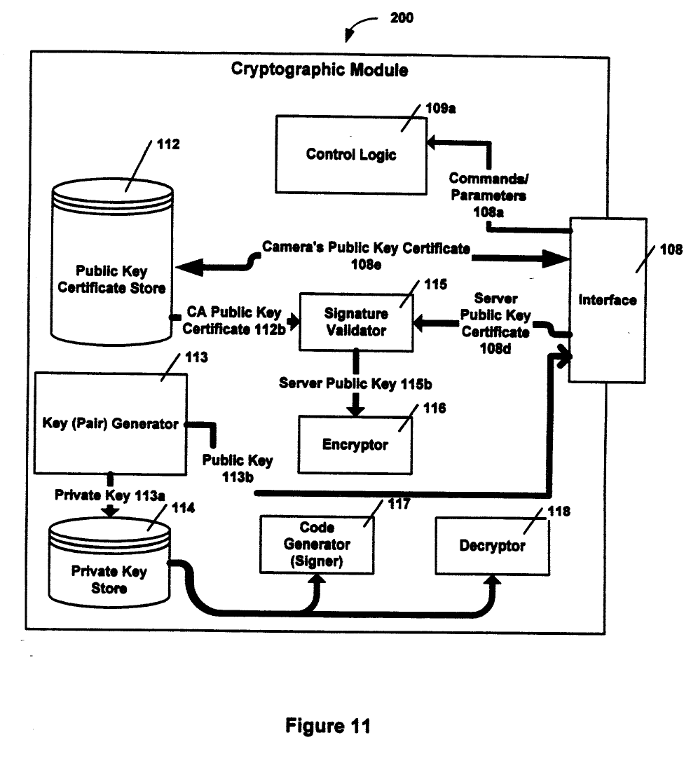

FIG. 11 illustrates a block diagram of a cryptographic module in accordance with the present invention. Additional cryptographic techniques are described herein in order to provide for mutual authentication; that is, the server can validate that the data has been obtained from a known, trusted source, but also the camera can validate that the data will be sent to a known, trusted server. Further, the protocol describes optionally adding encryption so as to obscure the contents of the data during transfer from the camera to the server. This embodiment is only one possible protocol, and other variant techniques and features are contemplated.

An imaging device may have an integrated, advanced cryptographic subsystem, such as that shown as element 200 in FIG. 11. FIG. 11 illustrates a plurality of components previously described, such as a code generator 107 that produces digital signatures, and a number of other components that may be utilized to support the described functionality. Cryptographic subsystem 200 may include a key generator 113 which can produce asymmetric key pairs. In an embodiment in which an advanced, hybrid (combined symmetric and asymmetric) cryptographic scheme is used, key generator 113 may contain a symmetric key generation function as well. The private key 113a created by key generator 113 is desirably never released from the cryptographic subsystem 200 and is stored by a private key store 114.

Public key certificates are stored by public key certificate store 112, which is preferably a storage or memory device. A number of components perform cryptographic operations in accordance with the invention. Hence cryptographic subsystem 200 may comprise: signature validator 115 generating a server public key 115a; encryptor 116; code generator 107 which generates digital signatures; and decryptor 118. Control logic in controller 109 controls the data flow and logic of the subsystem and exchange with external subsystems through communications interface 108.

In accordance with an apparatus as described with respect to FIG. 11, a trusted certificate authority (CA) is utilized. The CA (not shown) uses asymmetric key cryptography and related techniques. In particular, it is contemplated that the CA has an extremely well secured private key used to generate public key certificates from public keys submitted to it by, for example, imaging devices and biometric authentication servers. Likewise, it is assumed that the CA's public key certificate is very well known—this key certificate is used to validate that public key certificates were indeed signed by the CA.

An imaging device including a cryptographic subsystem 200, in addition to having internal key storage 112, 114 and signing capabilities 107, may also contain logic in key pair generator 113 to create asymmetric key pairs (public key and private key) in a manner known to the art. In addition, it is contemplated that the imaging device including cryptographic subsystem 200 has the ability to communicate a newly generated public key to a certificate authority that has the ability to sign the public key. The imaging device including cryptographic subsystem 200 may then reload the newly signed certificate in its internal store.

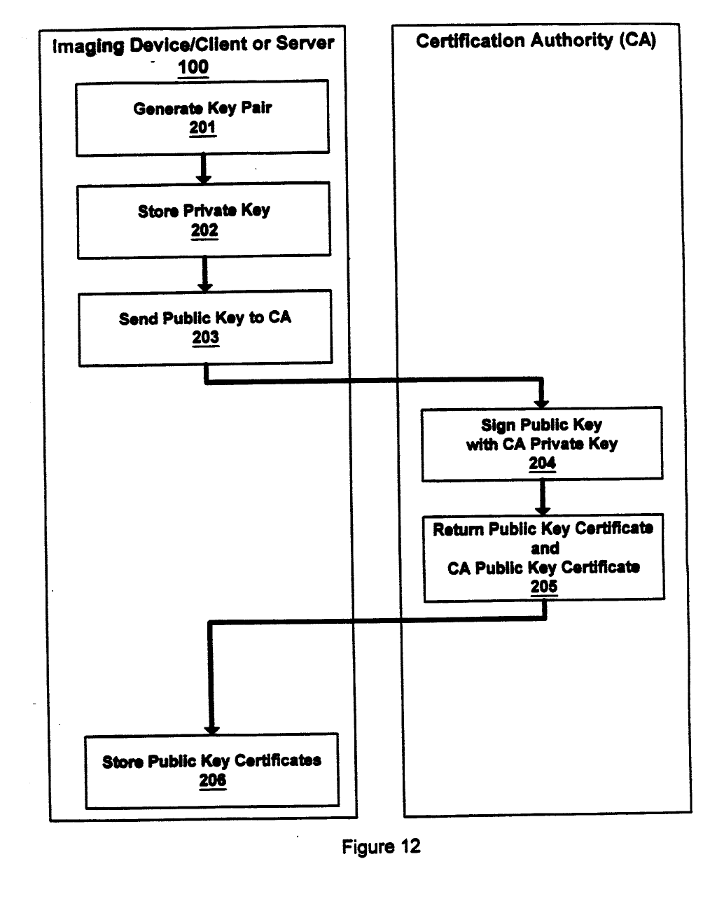

A flow diagram for an exemplary process of signing a key is illustrated in FIG. 12. In step 201, an imaging device including cryptographic subsystem 200 may generate an asymmetric key pair 113a and 113b using known cryptographic key generation techniques within key generator 113. Private key 113a is stored in an internal private key store 114 in step 202. Public key 113b and optionally other relevant information such as an identification code for the imaging device (such as device 100 or 100a described above) is sent to a CA in step 203. Other relevant information received by the CA may be incorporated into a public certificate 108e for the camera or other imaging device by a CA. Camera public certificate 108e is used to identify and authenticate imaging device 100, 100a. Exemplary imaging device identification numbers included within camera public certificate 108e may be an imaging device serial number, manufacturer, certificate expiration date or other identifying code.

In step 204, the CA signs public key 113b and optionally other relevant information of imaging device 100, 100a with CA private key to generate a public key certificate 108e for imaging device 100, 100a, and returns the public key certificate 108e to imaging device 100, 100a via communications interface 108 at step 205. The CA may also store public key certificate 108e in a data store associated with the CA. The CA also returns its own CA public key certificate 108d in step 205.

In step 206, imaging device 100, 100a stores its own public key certificate 108e, and CA public key certificate 108d in public key certificate store 112.

For mutual authentication protocol, the external server also desirably has the ability to generate asymmetric key pairs. FIG. 12 also illustrates an exemplary process of signing a server key. In step 201, an asymmetric key pair is generated by a server. The server stores the server private key in an internal store in step 202. In step 203, the server transmits the server public key to the CA so that a public key certificate for the server can be generated. As in the case of an imaging device, additional information can be incorporated into the certificate. The certificate is used to identify and authenticate the device.

The CA signs the server public key with the certificate authority's private key in order to generate a public key certificate for the server in step 204, and returns the public key certificate to the server in step 205. The CA may also store the public key certificate in its database. The CA also returns its own well-known public key certificate in step 205. The server stores its own public key certificate, and also the public key certificate of the CA in step 206.

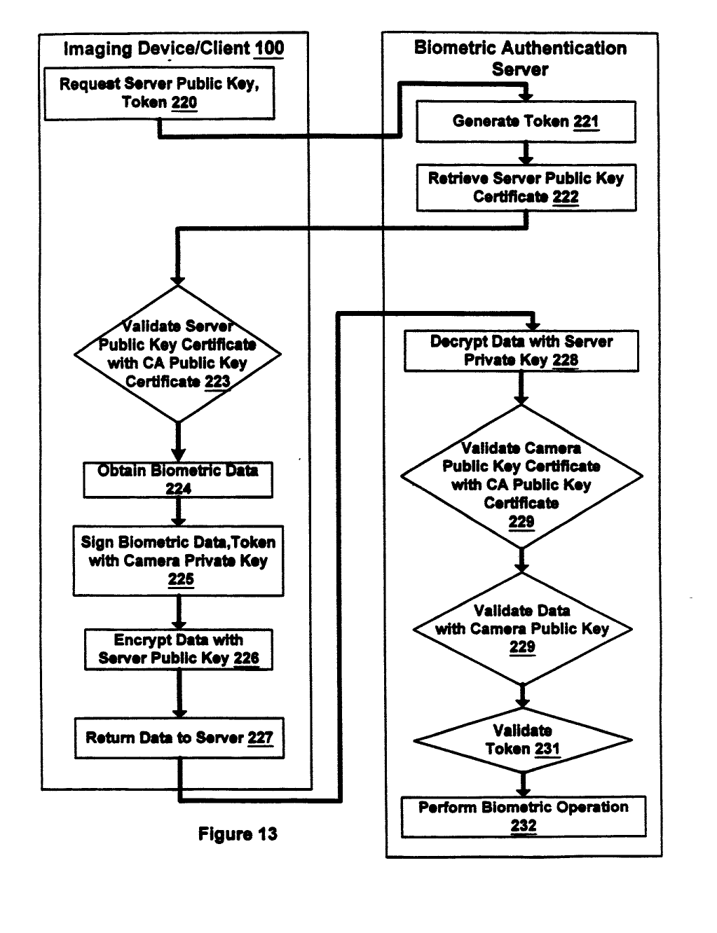

When an exchange of secure biometric information is desired, the client imaging device and server exchange information to determine if each is communicating with a truly authorized entity. This process is illustrated by the flow diagram in FIG. 13.

When a biometric sample is desired from a client device, such as an imaging device 100, 100a including a cryptographic subsystem 200, in step 220 the client requests an authentication server to provide its public key certificate and token (which may be used to prevent replay attacks as described above). The server generates a token in step 221 and retrieves the server's public key certificate in step 222. Token and certificate are sent to the imaging device. In step 223, the client uses the CA's public key certificate to validate the server's public key certificate with the cryptographic module's signature validator 115. This shows that the CA did indeed sign the server's public key. Since the camera trusts the CA, this step serves to authenticate the server to the camera. At this point, the camera trusts that it will send the biometric data to a truly authorized entity. If the camera cannot authenticate the server, it may not allow biometric samples to be obtained.

At step 224, the client obtains the biometric sample, signs it at step 225 using the token, biometric data, and the camera's private key, with the code generator 117. The client prepares a data package containing the token, biometric data, signature, and the camera's public key certificate. The signature will serve as the means to determine if data integrity has been maintained during the exchange.

At this point, if the client contains an encryptor 116, in addition to signing, the data package may be encrypted in step 226 using the public key of the server obtained from the certificate sent in to the camera. At step 227, the data package is returned to the server from the client through the communication interface 108. If the data package is encrypted, privacy of the exchange is maintained.

In step 228, the server receives the communications package and, if the package has been encrypted, the server uses its private key to decrypt the package. The server checks the validity of the client's public key certificate using the CA's public key certificate at step 229. Since the server trusts the CA, this step serves to authenticate the client to the server. At this point, the server has identified the client and knows that the client is a truly authorized entity. The server may choose to not process samples from a non-authorized entity—indeed, it may signal other intervention in some manner. Thus, it can be said that the client and server have been mutually authenticated.

The server uses the public key certificate from the client to validate the signature of the biometric data and token, at steps 230 and 231. This tests that data integrity has indeed been maintained—if the signature of the data is validated then the data must not have been corrupted in any way. At step 232, the operation (such as template matching operation) is performed.

If the client contains a decryptor 118, the client can decrypt data sent to it that has been encrypted using the camera's public key. Decryptor 118 may also be used as described previously to decrypt templates sent to imaging device 100, 100a camera for biometric matching.

There are other possible variations of the schemes proposed above but the general principle of using digital authentication schemes to secure images used in biometric verification and identification against substitution/tampering is consistent throughout.

Although we have shown certain preferred embodiments of our method an apparatus it should be distinctly understood that our invention is not limited thereto but may be variously embodied within the scope of the following claims.

What is claimed is:

1. An apparatus for collecting and transmitting biometric data over a network, the apparatus comprised of:
a sensor to collect biometric data; and
a biometric template generator, coupled to the sensor, to convert the biometric data into a biometric template.

2. The apparatus of claim 1, further comprising an output interface, coupled to the biometric template generator, to output the biometric template to a network.

3. The apparatus of claim 1, further comprising a security code generator coupled to the biometric template generator to sign the biometric template.

4. The apparatus of claim 3, wherein the security code generator implements a signing technique using at least one of a key and a token.

5. The apparatus of claim 3, further comprising an output interface, coupled to the biometric template generator, to output the signed biometric template to a network.

6. The apparatus of claim 1, further comprising an image processor coupled between the sensor and the biometric template generator to determine whether the biometric data is suitable for biometric template generation.

7. The apparatus of claim 1, further comprising a biometric matcher to compare a two biometric templates to determine whether the two biometric templates match and to generate a match result.

8. The apparatus of claim 7, wherein the match result is signed.

9. The apparatus of claim 1, further comprising a security module to decrypt and validate a previously enrolled biometric template received via the network.

10. The apparatus of claim 9, wherein the received previously enrolled biometric template is signed, encrypted, and comprises a validation key.

11. A cryptographic system, comprising:
an imaging device for collecting biometric data;
a code generator to generate a digital signature
a key generator to generate at least one key;
a private key storage device coupled to the key generator; and
a public key storage device coupled to the key generator.

12. The system of claim 11, further comprising:
a signature validator to generate a public key; and
an encryptor to encrypt data using the public key; and
a decryptor.

13. The system of claim 11, wherein the key generator comprises logic to create an asymmetric key pair.

14. A method of providing security to biometric data, comprising:
generating a key pair comprising a public key and a private key at an imaging device;
storing the private key in a storage device at the imaging device;
transmitting the public key from the imaging device to a certification authority;
generating an imaging device public key certificate at the certification authority;
generating a certification authority public key certificate at the certification authority; and
transmitting the imaging device public key certificate and the certification authority public key certificate to the imaging device.

15. The method of claim 14, further comprising storing the imaging device public key certificate and the certification authority public key certificate in the storage device at the imaging device.

16. The method of claim 14, further comprising:
generating an asymmetric key pair comprising a public key and a private key at server;
storing the private key in a storage device at the server;
transmitting the public key from the server to a certification authority;
generating a server public key certificate at the certification authority;
generating a second certification authority public key certificate at the certification authority; and
transmitting the server public key certificate and the second certification authority public key certificate to the imaging device.

17. A method of exchanging biometric information between an imaging device and a server, comprising:
authenticating the server at the imaging device;
obtaining a biometric sample at the imaging device;
signing the biometric sample at the imaging device;
generating a data package comprising the biometric sample, a token, the signature, and an imaging device public key certificate;
transmitting the data package to the server;
receiving the data package at the server;
authenticating the imaging device at the server;
validating the signature and the token at the server.

18. The method of claim 17, wherein authenticating the server at the imaging device comprises:
sending a request for a server public key certificate and the token from the imaging device to the server;
generating the token at the server;
retrieving the server public key certificate from a storage device;
transmitting the server public key certificate and the token to the imaging device; and
validating the server public key certificate at the imaging device.

19. The method of claim 18, wherein validating the server public key certificate at the imaging device comprises using a certification authority public key certificate.

20. The method of claim 17, further comprising encrypting the data package using the server public key certificate prior to transmitting the data package to the server, and decrypting the data package at the server.
